(19) United States
(12) Patent Application Publication
(10) Pub. No.: US 2015/0207691 A1
(43) Pub. Date: Jul. 23, 2015

(54) PRELOADING CONTENT BASED ON NETWORK CONNECTION BEHAVIOR

(71) Applicant: Google Inc., (US)

(72) Inventor: Thomas Graham PRICE, San Francisco, CA (US)

(73) Assignee: Google Inc., Mountain View, CA (US)

(21) Appl. No.: 13/791,794

(22) Filed: Mar. 8, 2013

(51) Int. Cl. H04L 12/24

(52) U.S. Cl. CPC H04L 41/16

(57) ABSTRACT

Methods for preloading content based on user content browsing behavior and network connectivity behavior are provided. In one aspect, a method includes receiving an indication of predicted content to be requested by a user of a mobile device, and determining network connectivity behavior for a local area network connection of the mobile device. The method also includes identifying at least a subset of the predicted content to load to the mobile device based on the network connectivity behavior of the local area network connection of the mobile device, and loading the subset of the predicted content while the mobile device is connected to the local area network. Systems and machine-readable media are also provided.

### BACKGROUND

1. Field

The present disclosure generally relates to the transmission of data over a network, and more particularly to the use of a computing device to determine when to load data over a network.

2. Description of the Related Art

Mobile device users commonly browse for web content, such as web pages, videos, and music, according to daily patterns. For example, a typical mobile device may visit certain web sites for news and weather in the morning before work, certain social networking web sites during the day while at work, and certain sports and entertainment web sites in the evening after returning home from work. If the web sites are downloaded over a mobile network, such as a cellular telephone data network, the downloads can vary in speed and consistency based on the network connectivity of the mobile device. Additionally, mobile device content downloads on mobile networks can reduce the availability of remaining data for download for mobile devices having a download limit with an associated data plan. Furthermore, establishing a connection with a mobile network consumes battery resources for a mobile device.

### SUMMARY

According to one embodiment of the present disclosure, a computer-implemented method for preloading content based on user content browsing behavior and network connectivity behavior is provided. The method includes receiving an indication of predicted content to be requested by a user of a mobile device, and determining network connectivity behavior for a local area network connection of the mobile device. The method also includes identifying at least a subset of the predicted content to load to the mobile device based on the network connectivity behavior of the local area network connection of the mobile device, and loading the subset of the predicted content while the mobile device is connected to the local area network.

According to another embodiment of the present disclosure, a system for preloading content based on user content browsing behavior and network connectivity behavior is provided. The system includes a memory that includes instructions, and a processor. The processor is configured to execute the instructions to receive an indication of predicted content to be requested by a user of a mobile device based on a content browsing history of the user, and determine network connectivity behavior includes at least a time of day and duration of when the mobile device has previously connected using a local area network connection of the mobile device. The processor is also configured to execute the instructions to identify at least a subset of the predicted content to load to the mobile device based on the network connectivity behavior of the local area network connection of the mobile device, and load the subset of the predicted content while the mobile device is connected to the local area network.

According to a further embodiment of the present disclosure, a machine-readable storage medium includes machine-readable instructions for causing a processor to execute a method for preloading content based on user content browsing behavior and network connectivity behavior is provided. The method includes receiving an indication of predicted content to be requested by a user of a mobile device based on a content browsing history of the user, the predicted content includes addresses of the predicted content and a probability of loading the predicted content, and determining network connectivity behavior includes at least a time of day and duration of when the mobile device has previously connected using a local area network connection of the mobile device. The method also includes identifying at least a subset of the predicted content to load to the mobile device based on the network connectivity behavior of the local area network connection of the mobile device, and loading the subset of the predicted content while the mobile device is connected to the local area network.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for preloading content based on user content browsing behavior and network connectivity behavior.

FIG. 2 is a block diagram illustrating an example client and server from the architecture of FIG. 1 according to certain aspects of the disclosure.

FIG. 3 illustrates an example process for preloading content based on user content browsing behavior and network connectivity behavior using an example client of FIG. 2.

FIG. 4 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system loads, to a mobile device of a user, predicted content (i.e., downloading content prior to receiving a user request for the content, or “preloading”) for the user based on the user's content browsing history and the connection of the mobile device to a network. Specifically, the disclosed system determines when a user is typically connected to a local area or “non-mobile” network, such as a Wi-Fi network, and the average duration of the connection(s) in order to determine how much content can be downloaded during that duration of time. The system then identifies content the user is likely to download in the future on the mobile device based on the user's content browsing behavior, and downloads or “pre-fetches” the content to the mobile device while the mobile device is connected to the local area network. The amount of content that is downloaded can depend on the expected duration of a connection to the local area network based on past network connection behavior. In certain aspects, identified content that is determined to have a probability of download by the user greater than a predetermined amount is downloaded while the mobile device is connected to the local area network.

In certain aspects, when the disclosed system receives a request to load content that has been preloaded, the system determines whether the preloaded content is still valid (e.g., if the preloaded content has been superseded by a current version of the content). The determination may be made by comparing a hash value of the preloaded content with a hash value of the current version of the content. If the hash values do not match, the disclosed system downloads the current version of the content for display on the mobile device.

Although many examples provided herein describe a user's information being stored in memory, each user must grant explicit permission for such user information to be stored. The explicit permission may be granted using privacy controls integrated into the disclosed system. If stored or requested user information includes demographic information, then the demographic information is aggregated on a group basis and not by individual user. Each user is provided notice that such user information will be stored with such explicit consent, each user may at any time end having the user information stored, and each user may delete their stored user information. The stored user information may be encrypted to protect user security.

The user can at any time delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely a server). In many examples, the user information does not include and/or share the specific identification of the user (e.g., the user's name) unless otherwise specifically provided or directed by the user.

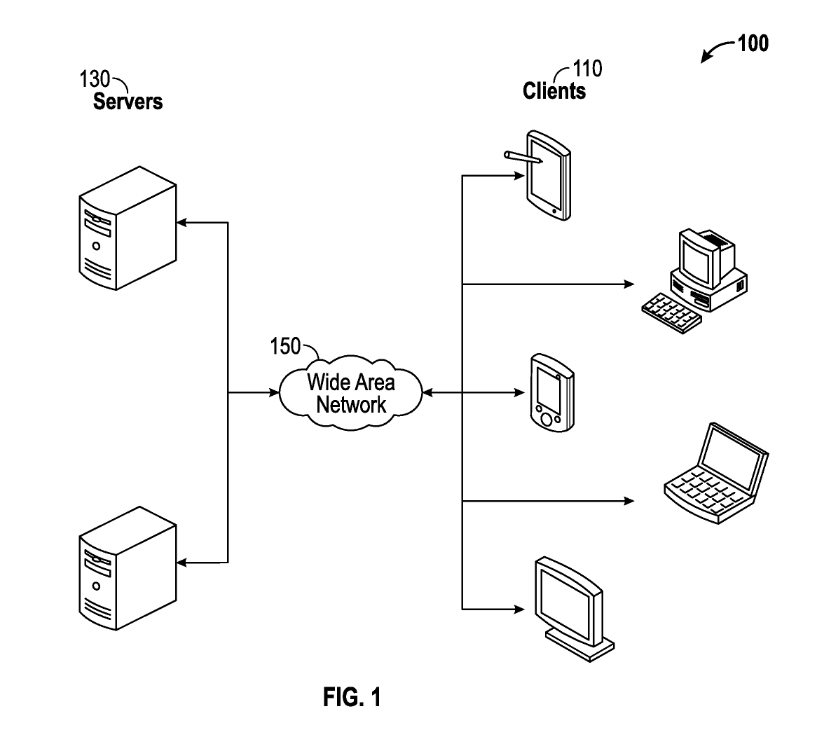

FIG. 1 illustrates an example architecture 100 for preloading content based on user content browsing behavior and network connectivity behavior. User content browsing behavior includes, for example, content a user typically views and when the user is connected to a network. The architecture 100 includes servers 130 and clients 110 connected over a wide area network (WAN) 150 (e.g., a “cellular network” or “mobile network”).

Each of the clients 110 is configured to download, install, and run an application as disclosed herein. The application can be, for example, a web browser, document editor, or content viewer. The application is configured to run on clients 110 that are mobile or non-mobile but is particularly suited for mobile clients 110. The clients 110 can be, for example, desktop computers, laptop computers, mobile devices (e.g., a smartphone, tablet computer, or PDA), set top boxes (e.g., for a television), video game consoles, or any other devices having appropriate processor, memory, and communications capabilities. In certain aspects, certain advantages of the application, such as a faster web page loading time in response to a query submission, are most salient on clients 110 that are mobile devices or that otherwise have slower processing and network data download speeds when not connected to a local area network.

The application can be downloaded over the WAN 150 or may already be available on the client 110. The application on the client 110 is configured to download content, such as web pages or documents, from one or many of the servers 130 for viewing in the application. For purposes of load balancing, multiple servers 130 can also host the content for downloading to the application. The servers 130 can be any device having an appropriate processor, memory, and communications capability for hosting the content. The WAN 150 can include, for example, a broadband network (BBN), the Internet, and the like. Further, the WAN 150 can include, but is not limited to, any one or more of the following network topologies, including a bus network, a star network, a ring network, a mesh network, a star-bus network, tree or hierarchical network, and the like.

Each client 110 may access the WAN 150 through an intermediary network connection, namely a connection to a local area network (LAN). The client 110 may use the client's connection to the LAN to connect to the WAN 150. The LAN can include, for example, any one or more of a personal area network (PAN), a campus area network (CAN), a metropolitan area network (MAN), and the like.

The application, once downloaded from a server 130 and installed and executed on a client 110, is configured to receive a user's authorization to analyze a user's content browsing behavior and optionally store information on the user behavior locally in memory on the client 110. Specifically, the application analyzes when the user is connected to the LAN (e.g., a Wi-Fi connection), content the user tends to download when connected to the WAN 150, and optionally when the user is connected to the WAN 150. Based on the user behavior, the application predicts and automatically downloads when the user is connected to the LAN content that the user tends to download when the user is connected to the WAN. If the user when connected to the WAN requests to download the predicted content that has already been automatically downloaded when connected to the LAN, the application determines whether the downloaded content is still valid (e.g., not expired relative to the content that is currently available for download from the server 130). The determination may be made by comparing a hash value of the downloaded content with a hash value of the current version of the content. If the hash values do not match, the application downloads a current version of the content for display in the application. If, however, the hash values do match, the application displays the downloaded content in response to the user's request, thereby saving the user from downloading the content from the WAN 150.

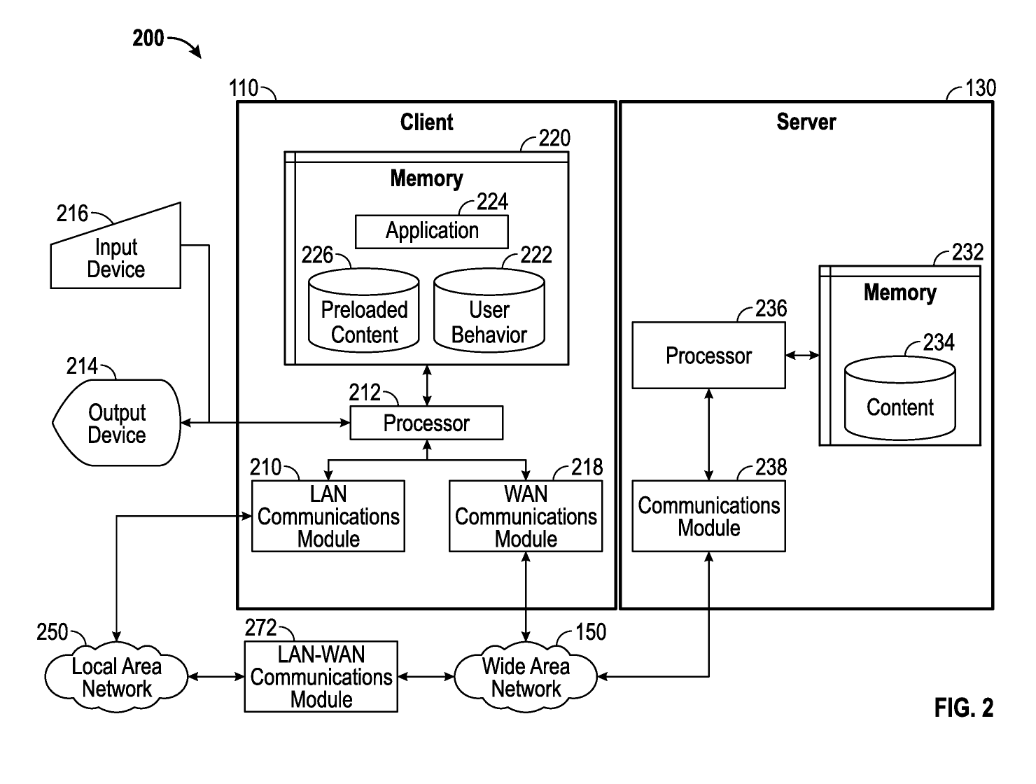

FIG. 2 is a block diagram illustrating an example server 130 and client 110 in the architecture 100 of FIG. 1 according to certain aspects of the disclosure. The client 110 is connected to the WAN 150 directly and indirectly via the local area network 140. Specifically, the client 110, which can be, for example, a mobile device, is connected to the LAN 250 through a LAN communications module, such as a Wi-Fi networking card. The client 110 is connected to the WAN 150 through a WAN communications module, such as a 3G or LTE networking card.

The local area network 140 is connected to the wide area network 150 using, for example, a LAN-WAN communications device 272 such as a broadband modem. The server 130 is also connected to the wide area network 150 via a communications module 238. The communications module 238 is configured to interface with the WAN 150 to send and receive information, such as content, requests, responses, and commands to other devices on the wide area network 150, and the communications modules 210, 218 and 238 are configured to interface with the LAN 250 or WAN 150 to also send and receive information with other devices on the WAN 150. The communications modules 210, 218 and 238 can be, for example, modems, Ethernet cards, or wireless network cards.

The client 110 includes a processor 212, the LAN communications module 210, the WAN communications module 218, and a memory 220 that includes an application 224 and user behavior 222 associated with the application. The LAN communications module 210 can be configured for a wireless (e.g., Wi-Fi) network connection or a wired network connection. The application 224 can be, for example, a web browser, document editor, or content viewer. The user behavior 222 includes information indicating a determination of at least a time of day and duration of when the client 110 has previously connected to the LAN 250 and an indicator of what content 234 the user downloads from the memory 232 of the server 130 (e.g., when connected to the WAN 150 and not connected to the LAN 250). For example, the user behavior 222 can include information indicating the user is connected to the LAN 250, on average, between the hours of 6:00 PM to 8:00 AM on weekdays and 10:00 PM to 6:00 PM on weekends. As another example, the user behavior 222 can include an indicator that when the client 110 is connected to the WAN 150, the user visits the sports website “wwx.sports.com,” the financial website “wwx.finances.com,” and the news website “wwx.news.com.” The user behavior 222 can optionally include information indicating a time during which the user is connected to the WAN 150. For example, the user behavior 222 can include information indicating the user is connected to the WAN 150, on average, between 8:00 AM to 6:00 PM. The content 234 can include, for example, web pages, video files, audio files, documents, or other downloadable data.

The client 110 also includes an input device 216, such as a keyboard or mouse, and an output device 214, such as a display. The processor 212 of the client 110 is configured to execute instructions, such as instructions physically coded into the processor 212, instructions received from software in memory 240, or a combination of both. For example, the processor 212 of the client 110 executes instructions from the application 224 to receive an indication of predicted content to be requested by a user of a mobile device and determine network connectivity behavior to the LAN 250 by the client 110 (e.g., by referencing the user behavior 222 stored in memory 220). The network connectivity behavior to the LAN 250 can be determined, for example, by identifying times of day when a user of the client 110 is typically connected to the LAN 250. Specifically, the time windows for the connections to the LAN 250 are identified.

The processor 212 is also configured to identify at least a subset of the predicted content to load to the client 110 (e.g., and store in memory as preloaded content 226) based on the network connectivity behavior of the LAN 250 connection of the client 110. For example, a predictive model based on the user's content viewing activity (e.g., for each day) is used to predict a probability p that a user will load any particular item of content (e.g., from content 234 on the server 130) outside one of the identified LAN 250 connection windows. In certain aspects, the identification includes selecting the subset of the predicted content 234 to load to the client 110 based on the duration of when the client 110 has previously connected to the LAN 250. For example, the predictive model also models the LAN 250 connection windows to determine how much content can be downloaded and stored in memory 220 (e.g., as the preloaded content 226) during a typical LAN 250 connection window. In certain aspects, a user of the client 110 can designate in the application 224 content that is to be excluded from preloading, such as private content, encrypted content, or large data files.

The processor 212 is further configured to load at least a subset of the predicted content 234 while the client 110 is connected to the LAN 250. For example, if the probability p that an item of content will be viewed when the client 110 is directly connected to the WAN 150 exceeds a threshold q, which may be defined by the user or defined based on past user behavior, the application 224 downloads and stores (or “preloads”) the predicted item of content 234 from the server 130 during a LAN 250 connection window. This permits the user to have preloaded content 226 that the user regularly views so that the preloaded content 226 is immediately available on the client 110.

In certain aspects, the indication of the predicted content 234 includes addresses for the location of the predicted content 234, such as Uniform Resource Locators (URLs). For example, the user behavior 222 can include an indicator that when the client 110 is connected to the WAN 150, the user visits the sports website “wwx.sports.com,” the financial website “wwx.finances.com,” and the news website “wwx.news.com.” The indication of the predicted content 234 can further include a probability of loading value associated with each address. For example, the user behavior 222 can indicate that there is a probability of 0.7 that the user will visit the website “wwx.sports.com” when connected to the WAN 150, a probability of 0.3 that the user will visit the website “wwx.finances.com” when connected to the WAN 150, and a probability of 0.25 that the user will visit the website “wwx.news.com” when connected to the WAN 150. The content and associated probabilities are based on a browsing history of the user in the application 224. Relevant information regarding the user's browsing history is stored in the user behavior 222 with the consent of the user.

In certain aspects, when the processor 212 receives a request from the user to load the predicted content 234 (e.g., by a user entering a URL for a preloaded web site into the application 224), the processor 212 is configured to determine whether the preloaded content 226 has been superseded by a current version of content 234 existing on the server 130.

The determination can be made, for example, by the processor 212 comparing a first hash value associated with the preloaded content 226 with a second hash value associated with the current content 234 on the server 130 to determine whether the first hash value and the second hash value match. When the first hash value and the second hash value do not match, the determination indicates the preloaded content 226 has been superseded by the content 234 on the server 130. When the first hash value and the second hash value match, the determination indicates the preloaded content 226 has not been superseded by the content 234 on the server 130. When the determination indicates the preloaded content 226 has been superseded, the processor 212 is configured to download from the server 130 and provide the content 234 is provided for display in the application 224 on the output device 214. In certain aspects, when the determination indicates the preloaded content 226 has been superseded, but no network connection is available (e.g., to LAN 250 or WAN 150, such as in an underground subway), the preloaded content 226 may be provided for display along with a notification that the preloaded content 226 may be superseded (or “stale”). When the determination indicates the preloaded content 226 has not been superseded, the preloaded content 226 is provided for display in the application 224 on the output device 214.

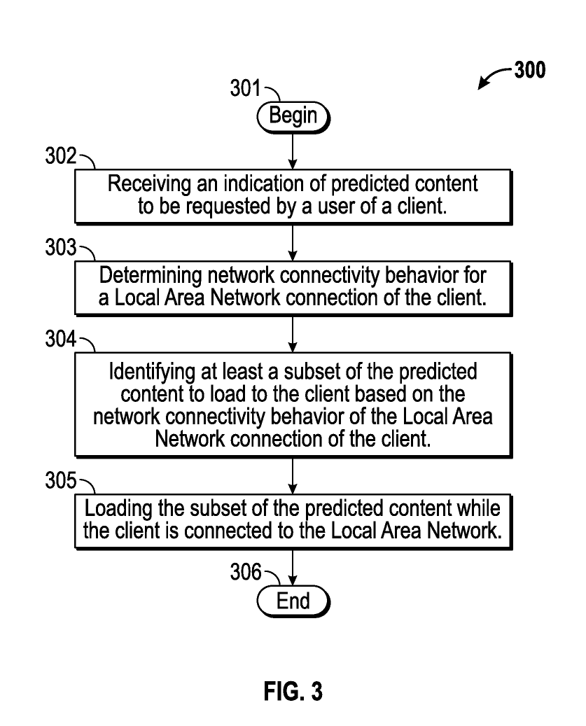

FIG. 3 illustrates an example process 300 for preloading content based on user content browsing behavior and network connectivity behavior using the example client 110 of FIG. 2. While FIG. 3 is described with reference to FIG. 2, it should be noted that the process steps of FIG. 3 may be performed by other systems. The process 300 begins by proceeding from beginning step 301 when a user loads the application 224 to step 302 when an indication of predicted content 234 to be requested by a user of the client 110 is received. Next, in step 303, network connectivity behavior for a LAN 250 connection of the client 110 is determined, and in step 304 at least a subset of the predicted content 234 to preload to the client 110 based on the network connectivity behavior of the LAN 250 connection of the client 110 is identified. Finally, in step 305, the subset of the predicted content is loaded to the client 110 while the client 110 is connected to the LAN 250. The process 300 ends in step 306.

FIG. 3 set forth an example process 300 for preloading content based on user content browsing behavior and network connectivity behavior using the example client 110 of FIG. 2. An example will now be described using the example process 300 of FIG. 3, a client 110 that is a smartphone, an application 224 that is a web browser, and content 224 that includes web pages.

The process 300 begins by proceeding from beginning step 301 when the user loads the web browser 224 on the smartphone 110 to step 302 when the web browser, based on past user behavior 222 stored in memory 220, identifies predicted web page content 234 to preload based on a likelihood that the user will request the web page content 234. Next, in step 303, the application 224 references the user behavior 222 to identify when the user usually is connected to the LAN 250 (e.g., via a Wi-Fi communications module 210). The application 224 identifies that the user is usually connected to the LAN 250 for an hour between 7:00 AM and 8:00 AM. In step 304, a subset of the predicted web page content 234 is identified that can be downloaded within the one hour LAN 250 connection time frame, from 7:00 AM to 8:00 AM. The application 224 then waits until it is 7:00 AM. Finally, in step 305, when the time becomes 7:00 AM, the subset of the predicted web page content 234, namely certain web pages, is loaded to the smartphone 110 while the client 110 is connected to the LAN 250 between 7:00 AM and 8:00 AM. The process 300 ends in step 306.

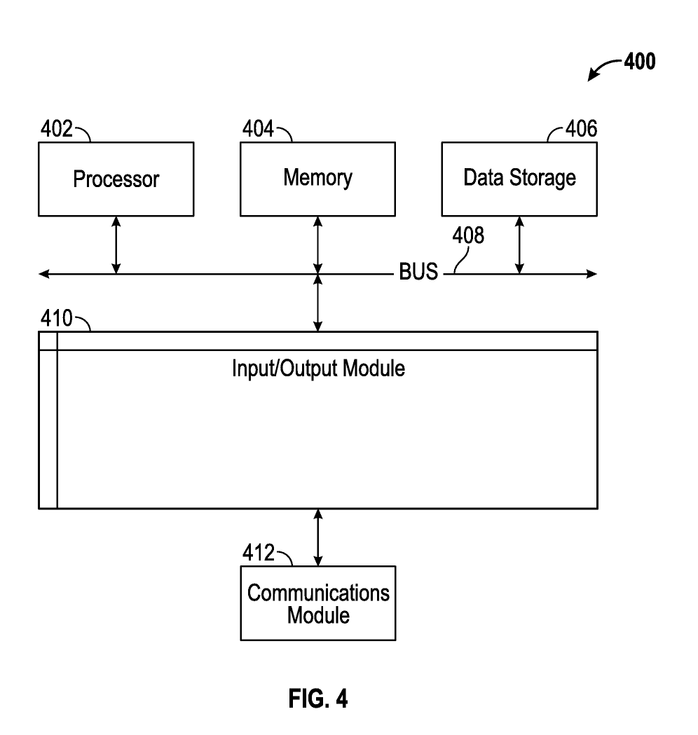

FIG. 4 is a block diagram illustrating an example computer system 400 with which the client 110 and server of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., client 110 and server 130) includes a bus 408 or other communication mechanism for communicating information, and a processor 402 (e.g., processor 212 and 236) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Example input/output modules 410 include data ports such as USB ports. The input/output module 410 is configured to connect to a communications module 412. Example communications modules 412 (e.g., LAN communications module 210, WAN communications module 218, and communications module 238) include networking interface cards, such as Ethernet cards and modems. In certain aspects, the input/output module 410 is configured to connect to a plurality of devices, such as an input device 414 (e.g., input device 216) and/or an output device 416 (e.g., output device 214). Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network (e.g., LAN communication network 250 or WAN communication network 150). The communications modules can be, for example, modems or Ethernet cards.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 402 for execution. Such a medium may take many forms, including, but not limited to, non-volatile media, volatile media, and transmission media. Non-volatile media include, for example, optical disks, magnetic disks, or flash memory, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A computer-implemented method for preloading content based on user content browsing behavior and network connectivity behavior, the method comprising:
receiving an indication of predicted content to be requested by a user of a mobile device;
determining network connectivity behavior for a local area network connection of the mobile device;
identifying at least a subset of the predicted content to load to the mobile device based on the network connectivity behavior of the local area network connection of the mobile device; and
loading the subset of the predicted content while the mobile device is connected to the local area network.

2. The computer-implemented method of claim 1, wherein the indication of the predicted content comprises addresses for a location of the predicted content.

3. The computer-implemented method of claim 2, wherein the indication of the predicted content further comprises a probability of loading value associated with each address.

4. The computer-implemented method of claim 1, wherein the indication is based on a content browsing history of the user.

5. The computer-implemented method of claim 1, wherein determining the network connectivity behavior for the local area network connection comprises determining at least a time of day and duration of when the mobile device has previously connected to the local area network.

6. The computer-implemented method of claim 5, wherein identifying the subset of the predicted content to load to the mobile device based on the network connectivity behavior of the local area network connection of the mobile device comprises selecting the subset of the predicted content to load to the mobile device based on the duration of when the mobile device has previously connected to the local area network.

7. The computer-implemented method of claim 1, wherein the local area network connection comprises at least one of a Wi-Fi connection or a wired network connection.

8. The computer-implemented method of claim 1, wherein the subset of the predicted content comprises at least one of a web page, a video file, or an audio file.

9. The computer-implemented method of claim 1, wherein the subset of the predicted content excludes content designated by the user.

10. The computer-implemented method of claim 1, the method further comprising:
receiving a request from the user to load the subset of the predicted content;
determining whether the subset of the predicted content has been superseded by current content;
when the determination indicates the subset of the predicted content has been superseded, providing the current content for display; and
when the determination indicates the subset of the predicted content has not been superseded, providing the subset of the predicted content for display.

11. The computer-implemented method of claim 10,
wherein determining whether the subset of the predicted content has been superseded by current content comprises comparing a first hash value associated with the subset of the predicted content with a second hash value associated with the current content to determine whether the first hash value and the second hash value match,
wherein when the first hash value and the second hash value do not match, the determination indicates the subset of the predicted content has been superseded, and
wherein when the first hash value and the second hash value match, the determination indicates the subset of the predicted content has not been superseded.

12. A system for preloading content based on user content browsing behavior and network connectivity behavior, the system comprising:
a memory comprising instructions; and
a processor configured to execute the instructions to:
receive an indication of predicted content to be requested by a user of a mobile device based on a content browsing history of the user;
determine network connectivity behavior comprising at least a time of day and duration of when the mobile device has previously connected using a local area network connection of the mobile device;
identify at least a subset of the predicted content to load to the mobile device based on the network connectivity behavior of the local area network connection of the mobile device; and
load the subset of the predicted content while the mobile device is connected to the local area network.

13. The system of claim 12, wherein the indication of the predicted content comprises addresses for a location of the predicted content and a probability of loading value associated with each address.

14. The system of claim 12, wherein identifying the subset of the predicted content to load to the mobile device based on the network connectivity behavior of the local area network connection of the mobile device comprises selecting the subset of the predicted content to load to the mobile device based on the duration of when the mobile device has previously connected to the local area network.

15. The system of claim 12, wherein the local area network connection comprises at least one of a Wi-Fi connection or a wired network connection.

16. The system of claim 12, wherein the subset of the predicted content comprises at least one of a web page, a video file, or an audio file.

17. The system of claim 12, wherein the subset of the predicted content excludes content designated by the user.

18. The system of claim 12, wherein the processor is further configured to:
receive a request from the user to load the subset of the predicted content;
determine whether the subset of the predicted content has been superseded by current content;
when the determination indicates the subset of the predicted content has been superseded, provide the current content for display; and
when the determination indicates the subset of the predicted content has not been superseded, provide the subset of the predicted content for display.

19. The system of claim 18,
wherein the processor being configured to determine whether the subset of the predicted content has been superseded by current content comprises the processor being configured to compare a first hash value associated with the subset of the predicted content with a second hash value associated with the current content to determine whether the first hash value and the second hash value match,
wherein when the first hash value and the second hash value do not match, the determination indicates the subset of the predicted content has been superseded, and
wherein when the first hash value and the second hash value match, the determination indicates the subset of the predicted content has not been superseded.

20. A machine-readable storage medium comprising machine-readable instructions for causing a processor to execute a method for preloading content based on user content browsing behavior and network connectivity behavior, comprising:
receiving an indication of predicted content to be requested by a user of a mobile device based on a content browsing history of the user, the predicted content comprising addresses of the predicted content and a probability of loading the predicted content;
determining network connectivity behavior comprising at least a time of day and duration of when the mobile device has previously connected using a local area network connection of the mobile device;
identifying at least a subset of the predicted content to load to the mobile device based on the network connectivity behavior of the local area network connection of the mobile device; and
loading the subset of the predicted content while the mobile device is connected to the local area network.
